(19) United States
(12) Patent Application Publication
(10) Pub. No.: US 2025/0094998 A1
(43) Pub. Date: Mar. 20, 2025

(54) AUTOMATED SECURITY MONITORING OF ONLINE AGENT-CUSTOMER INTERACTIONS USING MACHINE LEARNING

(71) Applicant: Twilio Inc, San Fancisco, CA (US)

(72) Inventors: Aman Srivastava, Bengaluru (IN); Nurul Quamar Khan, Bengaluru (IN)

(21) Appl. No.: 18/467,381

(22) Filed: Sep. 14, 2023

(51) Int. Cl. G06Q 30/015; G06N 20/00

(52) U.S. Cl. CPC G06Q 30/015; G06N 20/00

(57) ABSTRACT

Techniques and systems are described that perform automated protection of customer data by an interaction center that supports live agent-customer interactivity. The techniques include collecting agent activity data associated with an instance of a live agent-customer interaction. The instance of the live agent-customer interaction includes access by an agent to the customer data. The techniques further include generating one or more machine learning (ML)-readable feature vectors representative of at least one pattern in the agent activity data and processing the one or more ML-readable feature vectors using one or more ML models to generate an indication that the customer data is at risk. The techniques further include causing, responsive to the indication that the customer data is at risk, one or more remedial actions to be performed by the interaction center.

### TECHNICAL FIELD

Embodiments of the present disclosure relate to computing systems, and more specifically, to methods and systems for ensuring security of online agent-customer interactions.

### BACKGROUND

Contact centers (call centers) manage interactions between business representatives (agents) and customers (clients). Such interactions can use various communication channels, including audio-based channels (phone or audio conferencing), text-based channels (digital chats), video-based channels, social-media channels, and the like. Objectives of contact centers include achieving customer satisfaction, by using automation to speed up resolution times, offering customers an ability to submit surveys and other feedback, promoting events and sales, delivering order status updates, providing technical support, resolving problematic issues, and/or the like. Contact centers can come in possession of private customer data. Additionally, to facilitate achieving the above-stated and other objectives, contact centers can save and store contextual information from conversations with customers. This enables agents to be informed about potential issues and provide efficient customer support regardless of a specific communication channel that a customer may choose to contact the center. Such customer information needs to be protected from inadvertent exposure as well as malicious attacks that aim at misappropriating and misusing private data.

### BRIEF DESCRIPTION OF THE DRAWINGS

The disclosure is illustrated by way of example, and not by way of limitation, and can be more fully understood with references to the following detailed description when considered in connection with the figures, in which:

FIG. 1 illustrates a high-level component diagram of an example computing system that implements automated security monitoring of agent-customer interactions, in accordance with one or more aspects of the present disclosure.

FIG. 2 illustrates a workflow of an example agent security monitoring component of a customer interaction server that implements security monitoring of agent-customer interactions, in accordance with one or more embodiments of the present disclosure.

FIG. 3 illustrates an example training flow of an agent security monitoring component of FIG. 2, in accordance with one or more embodiments of the present disclosure.

FIG. 4 is a flow diagram of an example method of automated protection of customer data by an interaction center that supports live agent-customer interactivity, in accordance with one or more embodiments of the present disclosure.

FIG. 5 depicts an example computer system that can perform any one or more of the methods described herein, in accordance with some embodiments of the present disclosure.

### DETAILED DESCRIPTION

Traditional contact centers employ agents that work in physical proximity to each other and to supervisors (managers). Changes in work environments in recent years (including pandemic-induced changes) resulted in many call centers moving at least some of their operations to remote locations (e.g., agents' homes or other places). Proper supervision of remotely-operating (and, in some instances, remotely-trained) agents is an ongoing and challenging problem. Agents have access to customer data that can potentially be compromised or misused in a variety of ways. For example, an agent can be working from a home that is shared with multiple people. When the agent steps away from a computer (used by the agent to connect to the contact center), other people may gain access to the agent's session and customer's data. In some instances, an agent can be working from a public location, e.g., a cafeteria or an airport, where customer data can be at even greater risk of compromise. In some instances, an agent can misuse customer data for a number of reasons. In some instances, an agent can even be a part of a malicious group in which one member can undergo contact center training and gain credentials to access customer data while other member(s) of the same group can misuse those credentials. Timely identifying the above-described and other similar situations and protecting customer data from misuse, e.g., to implement a “zero-trust call center” remains an important and outstanding problem.

Aspects and embodiments of the instant disclosure address the above-mentioned and other challenges of the existing contact center technology by providing for systems and techniques capable of automatically identifying and evaluating instances of anomalous agent computer activity to ensure proper protection of customer data. In some embodiments, an agent security monitoring (ASM) application may be instantiated on the agent's computer and/or one or more servers of the contact center (also referred to a customer interaction center, or CIC, herein). The ASM may include multiple functions capable of detecting anomalous agent activity. For example, the ASM may include a voice recognition model that is used for continuous agent voice monitoring, e.g., by comparing agent's voice sampled at periodic time intervals (e.g., every several seconds) and comparing the sampled voice with one or more stored voice samples of the agent. If the voice recognition model determines that the compared voices belong to different people, the ASM may ask the agent to re-authenticate, e.g., to re-enter credentials (such as username and password), perform two-point authentication, and or the like. In some instances, the ASM may send a warning to the agent, including via a secondary (back-up) computing device (e.g., the agent's cell phone). In some instances, the ASM may send a warning to the agent's supervisor. The ASM may also include a data access monitoring component. The data access monitoring component may monitor agent's access to customer data and various other activities of the agent. The agent's activity (e.g., logs, transcripts of conversations, files accessed, browser actions, screens viewed by the agent, and/or the like) may be processed by an anomaly detection model, which may identify and flag any agent activity that deviates from normal agent activity. The flagged activity may be forwarded to an anomaly evaluation model, which may be trained to evaluate whether the anomalous agent activity is an innocent departure from a routine or a genuine security concern. For example, an agent may be taking longer to respond to customer's questions, the anomaly detection model may flag this situation as an anomaly, while the anomaly evaluation model may determine that the situation amounts to an innocent variation of a standard routine (e.g., possibly related to a network slowdown). In another example, upon receiving a request to take a call from a customer, an agent may access some of the customer's data before answering the customer's call, with the intention to reduce the resolution time of a customer's request (which can be a normal practice). However, instead of taking the call following the data access, the agent may decline to take the call. If this data access/call drop pattern is detected (by the anomaly detection model) to occur two or more times, the anomaly evaluation model may determine that the situation is suspicious. This may cause an action component of the ASM to take one or more remedial actions, such as issuing a request to the agent to re-authenticate, sending a warning to the agent's supervisor, or both. In some instances, the anomaly detection module may detect that the agent is asking a string of unusual questions, and the anomaly evaluation model may determine that the questions are of a prohibited type, e.g., eliciting personal identifiable information. In such instances, the action component may also take one or more remedial actions.

Various models, e.g., the anomaly evaluation model, may be continuously trained based on developer's/supervisor's feedback. For example, some of the situations evaluated as suspicious may in fact be normal. Conversely, some of the situations that are evaluated as innocent variations of the normal may in fact be situations in which customer data is at risk of being misused or compromised. A training engine may monitor such prediction mismatches and may retrain/update the anomaly evaluation model accordingly.

Numerous other embodiments and variations are disclosed herein. The advantages of the disclosed techniques include but are not limited to efficient automated identification and evaluation of anomalous and suspicious agent activity in agent-customer online interactions. This improves protection of customer data and minimizes the risks of inadvertent and/or malicious misuse of such data.

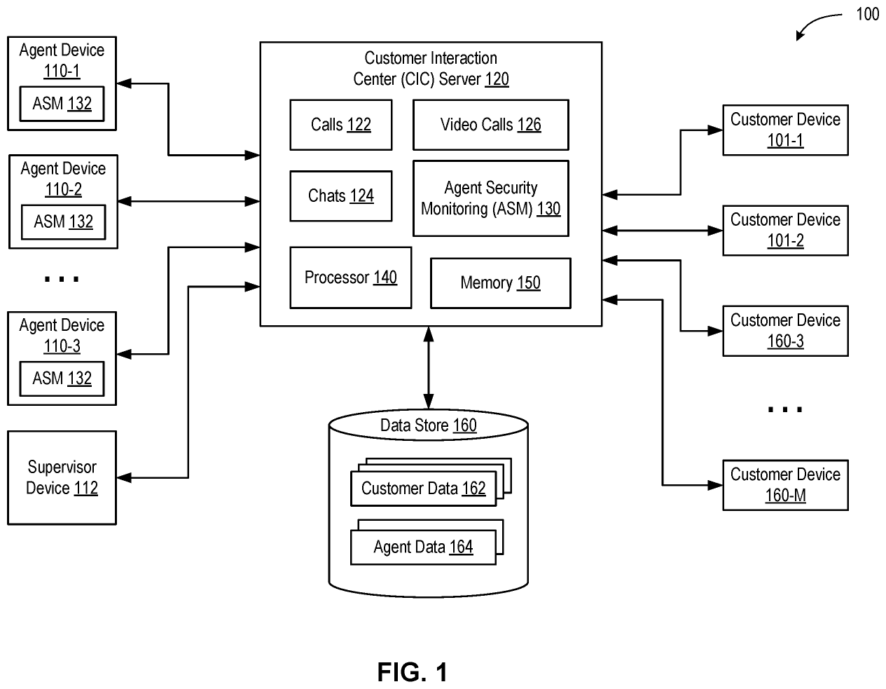

FIG. 1 illustrates a high-level component diagram of an example computing system 100 that implements automated security monitoring of agent-customer interactions, in accordance with one or more aspects of the present disclosure. The computing system 100 (also referred to as “system” herein) may implement security monitoring of agent-customer interactions that occur in the context of call centers, customer service centers, technical assistance centers, and/or other environments (called interaction centers herein) where remote live agent-customer interactions may occur. System 100 may support interaction of any number of customers connecting via respective customer devices 101-1 . . . 101-M with one or more customer interaction center (CIC) servers 120. Interaction of customers with CIC server 120 may be facilitated by one or more (e.g., N) agents operating remotely (from customer devices 101-j and/or CIC server 120) using respective agent devices 110-1 . . . 110-N. Agent device 110-k may be connecting to CIC server 120 over any suitable network (not shown explicitly in FIG. 1). In some embodiments, the network may be a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), and/or the like. In some embodiments, the network may include routers, hubs, switches, server computers, and/or a combination thereof. Customers 101-j may connect to CIC server 120 using the same network, a different network, a phone service or a social media. A provider of phone service or social media may be the same or different from the owner or operator of CIC server 120.

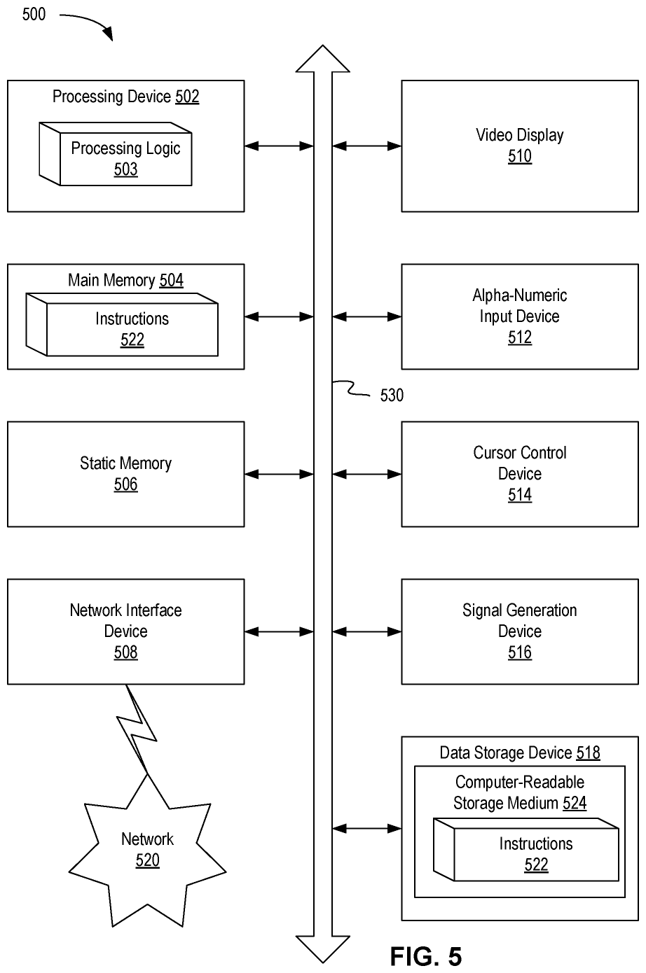

In some embodiments, any of CIC server 120 and/or agent devices 110-k may include a desktop computer, a laptop computer, a smartphone, a tablet computer, a server, a scanner, a wearable computing device, or any suitable computing device capable of performing the techniques described herein. In some embodiments, any of CIC server 120 and/or agent devices 110-k may be (and/or include) one or more computer systems 500 of FIG. 5. Customer devices 101-j may include any communication and/or computing devices that can be used for live communications with the agents, including phones, desktops, laptops, tablets, and/or the like.

CIC server 120 may support one or more interaction channels for customer connections to the CIC that facilitate agent-customer interactivity. For example, CIC server 120 may support calls 122 between agents and customers, chats 124 between agents and customers, video calls 126 between agents and customers, and/or other types of agent-customer communication channels that are not shown in FIG. 1 explicitly, including but not limited to social media channels, SMS messaging channels, email channels, and/or the like. For example, chats 124 should be understood as text-based agent-customer interactions, which may occur on any suitable text-based interface, e.g., computer screen, phone screen, voice-activated (e.g., speech transcribed) text messages, and/or the like. Calls 122 should be understood as agent-customer interactions during which an agent and a customer exchange information using speech but may also include a text-based component (e.g., a text-based dialog box for communicating textual information during audio calls). Video calls 126 should be understood as agent-customer interactions that include a video feed between an agent and a customer, e.g., a unidirectional video communication (agent-to-customer or customer-to-agent) or a bidirectional video communication. Video calls 126 may include a speech component and the text-based component. The types of communication channels for specific agent-customer interactions may be set by CIC server 120 administrators (supervisors) or may be selectable by agents, customers, and/or both.

During various agent-customer interactions (including but not limited to calls 122, chats 124, and/or video calls 126), the agents may access (e.g., through a file system of CIC server 120) various information relevant for such interactions. This information may include a record of a transaction that is at issue during a current interaction (e.g., a contested credit card charge, a technical support question, etc.), records of previous transactions by the same customer, details of a customer's subscription plan, specifics of hardware and/or software used by the customers, records made by other agents during previous agent-customer interactions with the same customer, CIC policies and regulations related to the current and/or previous transactions, and/or any other data. Some or any such accessed information may be private information that is to be protected from misuse and/or accidental or deliberate leakage.

In some embodiments, information related to agent-customer interactions may be stored in a data store 160 (database, data warehouse, etc.). Data store 160 may store any suitable raw and/or processed data, e.g., which may include customer data 162 and/or agent data 164. Customer data 162 may include a customer identification, a customer profile (e.g., customer address, details of customer subscriptions, settings, equipment, payment preferences, etc.), history of customer's transactions, history of customer's interactions with the CIC (e.g., transcripts and/or recordings of agent-customer interactions), and/or other information associated with the customer. Customer data 162 may also include customer's informed consent form that customer data be stored by CIC server 120 or data store 160. Agent data 164 may include agents' credentials, agents' locations, records of agent training, various records of agent activity during agent-customer interactions, including (but not limited to) records of questions to customers, statements made to customers, logs or other representations of computer activities performed using respective agent devices 110-k in conjunction with agent-customer interactions (e.g., in preparation, during, and/or after such interactions), and/or the like. The logs may include specific files, data structure, CIC resources, and/or screens accessed by the agents. Agent data 164 may further include voice samples of agents' voices, pictures of the agents, IP addresses of agents' computers, and/or other agent identification data.

Data store 160 may be implemented in a persistent storage capable of storing files as well as data structures to perform identification of data, in accordance with embodiments of the present disclosure. Data store 160 may be hosted by one or more storage devices, such as main memory, magnetic or optical storage disks, tapes, or hard drives, network-attached storage (NAS), storage area network (SAN), and so forth. Although depicted as separate from CIC server 120, data store 160 may be part of CIC server 120, and/or other devices. In some embodiments, data store 160 may be implemented on a network-attached file server, while in other embodiments data store 160 may be implemented on some other types of persistent storage, such as an object-oriented database, a relational database, and so forth, that may be hosted by CIC server 120 or one or more different machines coupled to CIC server 120 via a network.

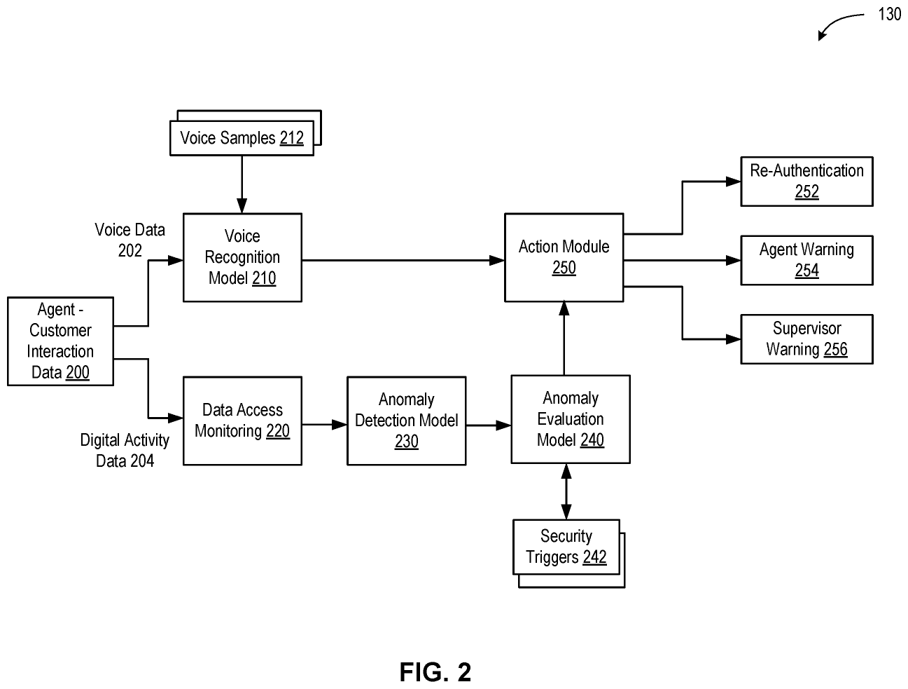

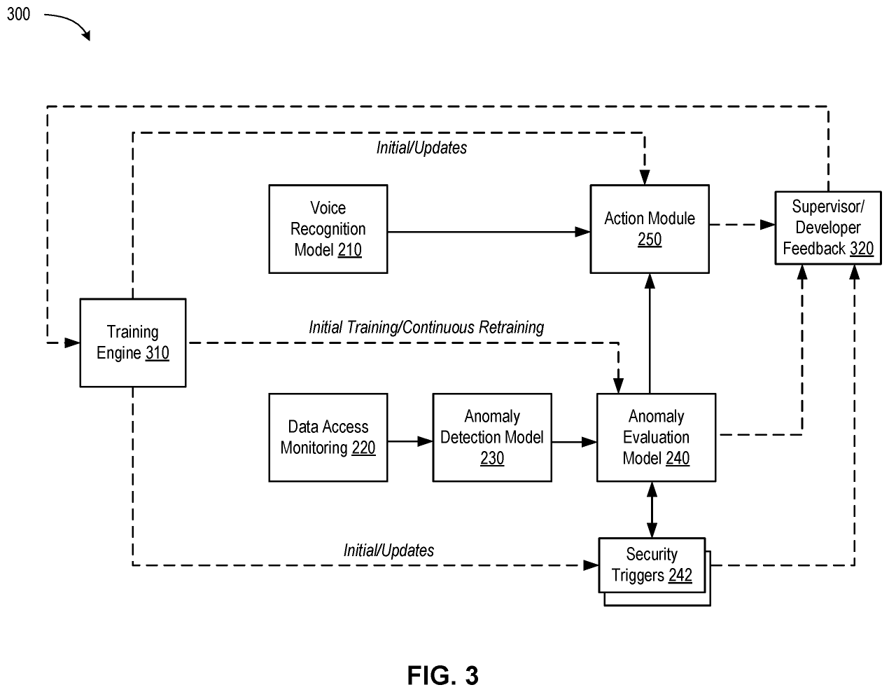

CIC server 120 may include an agent security monitoring (ASM) 130 component to perform real-time monitoring of agent-customer interactions to protect security of customer data. ASM 130 may operate according to embodiments disclosed in conjunction with FIG. 2 and May be trained using embodiments disclosed in conjunction with FIG. 3. In particular, ASM 130 may monitor voice and data activities of various agents of the CIC working via agent devices 110-k. ASM 130 may include one or more trained machine learning models, including but not limited to a voice recognition model, an anomaly detection model, and an anomaly evaluation model. ASM 130 may further include an action module component that implements one or more proactive and/or remedial actions to ensure security of customer data. In some instances, such actions may include informing agents' supervisor accessing CIC server 120 via supervisor device 112.

In some embodiments, the ASM may be a combination of a server component (ASM 130) and an agent component (ASM 132), such that some portion of the ASM is executed on agent device 110-k (e.g., data and agent activity collection) while another portion of the ASM (e.g., data and agent activity processing) is executed on CIC server 120. In some embodiments, the ASM may be executed entirely on CIC server 120. In some embodiments, CIC server 120 and/or any part of CIC server 120, e.g., ASM 130, may be implemented fully or partially on a computing cloud.

Computing operations of CIC server 120 may be performed (or supported by) by one or more processors 140, which may include one or more central processing units (CPUs), graphics processing units (GPUs), data processing units (DPUs), parallel processing units (PPUs), application-specific integrated circuits (ASICs), field-programmable gate arrays (FPGA), and/or any combination thereof. Processor(s) 140 may be communicatively coupled to one or more memory devices 150 that store instructions and data structures that support implementation of various techniques of ASM 130. Memory device(s) 150 may include random access memory (RAM), dynamic RAM (DRAM), synchronous DRAM (SDRAM)), flash memory, read-only memory (ROM), and/or the like.

FIG. 2 illustrates a workflow of an example agent security monitoring 130 component of a customer interaction server that implements security monitoring of agent-customer interactions, in accordance with one or more embodiments of the present disclosure. The workflow of ASM 130 may include collecting agent-customer interaction data 200, which may include any data related to an instance of agent-customer interaction, referred to as a session herein. The session may start with an agent accessing CIC server 120 and entering the agent's credentials, such as username and password, and/or performing a two-point authentication. The authenticated agent may be added to a group of agents available to respond to calls, chats, video calls, messaging boards, e.g., with available agents taking customer calls in some order (queue) of agents (e.g., with an agent who finished the last call earlier than other agents in the queue taking the next call). In some embodiments, agents may form multiple queues, e.g., based on agents' specializations (e.g., agents specializing in sales, credit card inquiries/fraudulent charges, tracking shipments, technical support, and/or the like).

In association with the session, the agent can generate voice data 202, which refers to any agent-spoken utterances, including but not limited to speech directed to the customer, but may also include conversations with other agents, technical support staff, and/or other people (or chatbots) assisting with resolving customer's issues. The voice data 202 may be sampled during the session and processed by a voice recognition model 210 (also known as speaker recognition model) at regular time intervals. In one non-limiting example, a 1-second snippet of the agent's speech can be sampled during each 5-second time interval and inputted into the voice recognition model 210, which may also take stored (e.g., as part of agent data 164 in FIG. 1) voice samples 212 of the agent's speech. The output of the voice recognition model 210 may be a binary classification that indicates whether the last snippet is produced by the same person as the person who produced voice samples 212. If the voice recognition model 210 determines that the voice data 202 does not match voice samples 212, the output of the voice recognition model may be used by an action module 250 to take one or more actions to protect customer data, e.g., as disclosed in more detail below. In some embodiments, a single mismatch between voice data 202 and voice samples 212 may trigger an action by the action module 250. In some embodiments, ASM 130 may have a built-in protection against false negatives with action module 250 taking an action provided that N last snippets of voice data 202 do not match stored voice samples 212, where N may be set at N=2, 3, or some other number.

In some embodiments, the output of the voice recognition model 210 may be a probability that the last snippet (N snippets) is produced by the same person as the person who produced voice samples 212. Correspondingly, action module 250 may take action provided that the last snippet (N snippets) of voice data 202 have a probability of matching stored voice samples 212 below a certain threshold, e.g., 50%, 60%, or some other empirically set threshold.

Voice recognition model 210 may operate using any known or newly developed voice recognition techniques. In some embodiments, voice recognition model 210 may be a machine learning model (e.g., a neural network model) that extracts voice and/or speech features (digital embeddings) from voice data 202 and processes the extracted features using one or more machine learning classifiers. In some embodiments, the extracted features may be based on mel-spectrograms of voice snippets that individually weight different spectral components of human voice/speech to mimic human hearing. The extracted features may be compared using the machine learning classifiers with features extracted from voice samples 212. In some embodiments, voice samples 212 may be stored in the form of previously extracted features of the agent's voice/speech. In some embodiments, voice recognition model 210 may be trained to perform text-independent recognition that does not rely on utterance of a specific text (a passphrase). Text-independent recognition allows verifying the agent's identity in the middle of an agent-customer interaction without reliance of the agent uttering the passphrase.

The machine learning used for voice recognition may deploy various techniques of pattern recognition, including but not limited to frequency estimation, hidden Markov models, Gaussian mixture models, pattern matching algorithms, matrix representation, vector quantization, decision trees, neural networks, and/or any combination thereof. Final binary classifications (“same voice/different voice”) or probabilistic classifications may be based on cosine similarity of feature vectors processed by neural network classifiers. Neural network classifiers can include convolutional neural layers, deconvolutional neural layers (e.g., U-net architecture), fully-connected (dense) layers, recurrent neural networks, long short-term memory networks, networks with attention (including transformer neural networks), and/or the like.

In addition to voice data 202, ASM 130 may use various digital activity data 204 for security monitoring of customer data. Digital activity data 204 may refer to any data generated during, in preparation for, and/or after the agent-customer interaction session, including but not limited to any files, screens, and/or data structures accessed by the agent, e.g., customer's profile. Customer's profile should be understood as any information stored in conjunction with the customer, e.g., customer's address(es), account number(s), history of customer's transactions, messages sent to or received from the customer, and/or the like. Digital activity data 204 may include logs of times spent on different tasks (e.g., time of viewing various files and materials), transcripts of questions directed to the customer (or other people, e.g., other agents) and responses received from the customer (or other people). Digital activity data 204 may further include any other digital data created in conjunction with the session.

Digital activity data 204 may be processed by a data access monitoring module 220 that may filter out data that is irrelevant or duplicative and may also represent the retained data in a format that can be input into an anomaly detection model 230. Although a single anomaly detection model is illustrated in FIG. 2, multiple anomaly detection models may be deployed, in some embodiments, with each model processing a certain class of digital activity data 204. For example, one model may process transcripts of agent's conversations (including chats), another model may process logs of file/data structures accessed by the agent, yet another model may process activity of user interfaces and communications devices under the agent's control, such as screenshots taken by the agent, text and/or graphics copied by the agent from the agent's screen, using a recorder (voice and/or video) on the agent's computer, calls made by the agent, statistics of a browser usage, and/or the like. In some embodiments, data access monitoring 220 may perform preprocessing of digital activity data, including removal of filler words from the transcripts, tokenizing the data, representing the data in the form of digital features, feature vectors, embeddings, etc., that one or more anomaly detection model(s) 230 may use as an input and/or the like.

The anomaly detection model(s) 230 may implement various techniques of identifying unusual events or patterns of usual events that occur in an unusual manner, e.g., in a way that is statistically different from normal sequence of events. The anomaly detection model(s) 230 may transform the input data into a multi-dimensional feature space with portions of the input data represented by “points” (feature vectors) in this space. The multi-dimensional space may be used as an efficient embeddings space to capture both the digital activity (e.g., files accessed and durations of those accesses) and the contextual information about the activity (e.g., a nature of customer's issue that the agent is trying to resolve). The anomaly detection model(s) 230 may identify unusual patterns of activities given the proper context. For example, accessing past credit card payments made by the customer may be normal when an issue with recurring payments is being addressed but may be anomalous when the agent is helping with a single recent charge to the customer's credit card made from abroad. In some embodiments, the anomaly detection model(s) 230 may deploy various clustering techniques (e.g., K-Nearest Neighbors Classifier) in the feature space, outlier detection techniques, principal component analysis, and/or any other suitable anomaly detection techniques. In some embodiments, anomaly detection model(s) 230 may use one or more machine learning models, e.g., support vector machines, neural networks, and/or the like.

Anomaly detection model(s) 230 may be trained using supervised training and/or unsupervised training. During supervised training a labeled dataset that includes both normal and anomalous digital activity data may be used to construct a predictive model that classifies input data among two classes (e.g., “normal” or “anomalous”) or among more than two classes (e.g., “normal,” “anomalous,” or “borderline”). In some embodiments, the labels need not specify whether the activity is malicious or innocent, as this type of determination may be performed by a different model (e.g., anomaly evaluation model 240). In some embodiments, training may include unsupervised training. During unsupervised anomaly detection training, no labeled data may be needed as the model assumes that most of the training data is normal and that anomalous training data is statistically different from the normal data. Based on these assumptions, anomaly detection model 230 learns to cluster (e.g., using a suitable similarity in the feature space, e.g., cosine similarity) normal data in points belonging to certain clusters and anomalous data in outlier points that are located substantially away from normal data clusters.

Anomaly detection model(s) 230 may flag data as anomalous or potentially anomalous (e.g., borderline) but, in some embodiments, need not make a final determination whether the digital activity data 204 gives rise to a concern about agent behavior and security of customer data. Such a determination may be made by an anomaly evaluation model 240, which may be trained using CIC-specific practices and requirements. Anomaly evaluation model 240 may also be a machine learning model that uses an output of one or more anomaly detection model(s) 230 flagged as anomalous or potentially anomalous. In some embodiments, anomaly detection model 240 may operate on intermediate feature vectors generated by anomaly detection model(s) 230, e.g., feature vectors that are used as inputs into a final classifier of the anomaly detection model(s) 230 or some other (earlier) intermediate outputs. In some embodiments, an input into anomaly evaluation model 240 may include portions of the original digital activity data 204 (suitably preprocessed by data access monitoring component 220) that have been flagged by anomaly detection model 230 as anomalous or potentially anomalous.

In some embodiments, anomaly detection model 230 may include a large language model (e.g., operating as part of CIC server 120 or externally, e.g., on a cloud) that is trained to process natural language inputs, such as records of agents' utterances made in the course of agent-customer interactions, and to output classifications of the inputs as normal, anomalous, borderline, and/or the like.

Anomaly evaluation model 240 may operate in conjunction with various security triggers 242 that have been identified during training as indicative of a potentially suspicious agent activity. Security triggers 242 may be CIC-specific and may depend on a particular task or issue that an agent is attempting to resolve. In some embodiments, security triggers 242 may include any pattern of unusual data accesses, e.g., an agent retrieving customer data outside the context of a customer call, or an agent retrieving customer data in preparation for the customer call but then declining to take the call (or repeatedly performing such retrieval-then-declining within a certain period of time). In some instances, security triggers 242 may include an agent asking for personally identifiable information from a customer or one of a list of explicitly forbidden questions (e.g., questions about passwords, security questions, and/or the like). In some instances, security triggers 242 may include taking screen captures of the agent's screen during a call, chat, or a video call. In some instances, security triggers 242 may include making a call to another person (other than agent's supervisor) during an agent-customer interaction. In some instances, security triggers 242 may include visiting unusual websites and/or web pages during agent-customer interactions. In some instances, security triggers 242 may include visiting certain high-sensitivity files and/or data structures with at least a certain frequency. For example, some senior agents may be granted access to such high-sensitivity files that are normally reserved for supervisor-level accesses. Senior agents may occasionally be granted access to these files. However, accessing such files/pages/data structures too often (e.g., at least a certain number per transaction or between transactions) may be one of security triggers 242. As disclosed in more detail in conjunction with FIG. 3, security triggers 242 may originally be set by developers (e.g., based on feedback from CIC supervisors) and later modified/updated as part of continuous training of ASM 130.

In some embodiments, security triggers 242 may be encoded via respective feature vectors (e.g., using a suitable tokenizer) and inputted into anomaly evaluation model 240 together with feature vectors representing anomalous portions of digital activity data 204. In some embodiments, security triggers 242 may be used as part of a final classification performed by anomaly evaluation model 240. For example, security triggers 242 may be encoded as clusters (e.g., cluster centroids) in the multi-dimensional (output) feature space of the anomaly evaluation model 240. Once it is determined, e.g., by the final classifier of the anomaly evaluation model 240, that one of inputted portions is represented by a feature vector (or a collection of feature vectors) in the feature vector space that has as similarity (e.g., cosine similarity) with the feature vectors of the cluster corresponding to one of security triggers 242, the anomaly evaluation model 240 may flag the match for an action module 250.

Action module 250 may collect flags from the voice recognition model 210 and the anomaly evaluation model 240 and determine an action to be taken. In some embodiments, action module 250 may maintain a lookup table, e.g., key-value table, where various possible flags generated by the voice recognition model 210 and/or the anomaly evaluation model 240 are stored as keys and corresponding actions are stored as values. Some example non-limiting actions are illustrated in FIG. 2. In particular, actions taken by action module 250 may include requesting the agent to perform re-authentication 252. Re-authentication 252 may be requested to be performed immediately after the current agent-customer session is concluded or without any further delay (e.g., if there is no currently ongoing session). Re-authentication may include a single sign-on (SSO) authentication, a two-point authentication, a biometric authentication (e.g., fingerprint/retina/picture authentication), or any other suitable authentication technique.

In some embodiments, the actions taken by action module 250 may include sending an agent warning 254 to the agent. In some embodiments, agent warning 254 may be sent to an agent's device that is different from the device (e.g., computer) the agent uses to perform CIC-related work. For example, agent warning 254 may be sent to the agent's phone. This may efficiently address situations where some other person has gained control of the agent's computer without the agent's knowledge.

In some embodiments, the actions taken by action module 250 may include sending a supervisor warning 256 to the agent's supervisor informing the supervisor about a pattern of unusual activity determined by ASM 130 to constitute a threat to customer data. The supervisor may then determine what further action (if any) needs to be taken. Supervisor warning 256 may include logs and/or other descriptions of the suspicious or unusual activity.

In some embodiments, a combination of actions may be taken by action module 250, e.g., re-authentication request 252 and agent warning 254, re-authentication request 252 and supervisor warning 256, and/or the like.

FIG. 3 illustrates an example training flow 300 of an agent security monitoring component of FIG. 2, in accordance with one or more embodiments of the present disclosure. Training 300 may be performed by a training engine 310, which may be a collection of software modules and hardware devices capable of training or otherwise modifying operations of ASM 130, e.g., as part of a suitable feedback loop. More specifically, training engine 310 may set initial security triggers 242, e.g., based on feedback from supervisors of a specific CIC service for which the ASM system is being configured. For example, supervisor(s) of the CIC service may provide a list of typical security concerns and breaches that the CIC service experienced in the past and/or security concerns and breaches that are known to have occurred in the relevant field of customer support. In particular, having received identification of a historical situation that gave rise to a security concern, training engine 310 may identify agent activity data associated with the historical situation, e.g., logs, transcripts of conversations, records of data saved/copied, and/or the like. Training engine 310 may use the identified data to prepare a training set that includes various representations of relevant agent activity data, as a training input into anomaly evaluation model 240, and the security flag as a target output (ground truth) that anomaly evaluation model 240 is being trained to predict.

During training, anomaly evaluation model 240 processes the training input and generates a training output (prediction). Training engine 310 then evaluates a difference between the training output and the target output (security flag or absence thereof) using a suitable loss function. Training engine 310 modifies parameters of the anomaly evaluation model 240 in the direction that reduces the difference (e.g., using various techniques of backpropagation, gradient descent, and/or other machine learning training techniques). In some embodiments, the loss function may be a binary cross-entropy loss function, although in other embodiments different loss functions may be used.

The training dataset may include training inputs with true security concerns (which may be labeled with “true” or any other equivalent label) and false security concerns (labeled as “false” or any other equivalent label). In some embodiments, both the training inputs with true security concerns and the training inputs with false security concerns may be the outputs of the anomaly detection model 230 (which may be trained prior to training the anomaly evaluation model 240) that are subsequently labeled (annotated) by a human developer (e.g., using feedback from one or more CIC supervisors). Initial training of anomaly evaluation model 230 may be continued with multiple sets of training input/target output until the model learns to output correct “true” or “false” classification. A set of the initial training data may be reserved for the model validation. In some embodiments, the initial training may continue until the percentage of wrong predictions (for the training set, validation set, or both) is below a target threshold, e.g., 10 percent, 5 percent, 2 percent, and/or the like.

In some embodiments, training inputs may be in the form of feature vectors (rather than portions of raw digital activity data) output by the anomaly detection model 230 or feature vectors used as inputs into the anomaly detection model 230 (e.g., pre-processed by a suitable tokenizer). In some embodiments, accuracy of the training may be evaluated based on such measures as precision (ratio of the number of situations correctly predicted as true security concerns to total number of all situations predicted—correctly and incorrectly—as true security concerns) and recall (ratio of the number of correctly predicted true security concerns to the sum of that number and a number of missed true security concerns). In some embodiments, separate target thresholds may be set for the accuracy and the recall. In some embodiments, an F1 score (a harmonic mean of the precision and the recall) may be used to evaluate accuracy of training of anomaly detection model 230.

Training of anomaly detection model 230 may be continuously performed after the model is deployed for inference of digital activity data, using supervisor/developer feedback 320. For example, feedback about accuracy of predictions of the model may be provided by CIC supervisor(s) and may include labeling various situations as true positives (correct classification of a situation as a true security concern by the model), false positive (incorrect classification of a situation as a true security concern), and false negative (incorrect classification of a situation as a false security concern). This additional continuous training may be performed as soon as a single misclassification (a false positive or a false negative) occurs. In some instances, additional training is performed once a certain number of misclassifications (e.g., a batch of two, five, or any other number of misclassifications) is collected. In some embodiments, additional training is performed using both instances of data for which incorrect classification has been predicted and instances of correctly classified data (to reinforce previously learned predictive abilities).

Training of anomaly detection model 230 may be performed in conjunction with updates of the security triggers 242. Initially, a set of security triggers 242 may be set based on supervisor/developer input. Subsequently, one or more of security triggers 242 may be removed (as resulting in too many false positives) or modified (to capture false negatives or to reduce a number of false positives). In some instances, one or more security triggers 242 may be added, e.g., to capture instances that have previously been predicted as false negatives. As one example, initial security triggers 242 may be set to include a screen capture made by the agent. Subsequently, it may be determined that the screen capture security trigger results in too many false positives as agents use screen captures to legitimately update customer information upon the completion of the call (or other agent-customer interactions). Correspondingly, the security trigger may be modified to exclude screen captures unless performed in conjunction with storing the screen capture on the agent's computer. As another example, security triggers 242 may initially include the agent accessing customer data in preparation to a call without accepting the call. Subsequently, the security triggers 242 may be modified to exclude instances of a single data access/not accepting the call and include only multiple (e.g., at least two) such instances occurring one after another or over a specific time.

In some embodiments, training may also include using the training engine 310 to add to, remove from, or modify actions performed by action module 250. For example, the key-value lookup-table used by action module 250 may be changed by adding some actions in response to specific security concerns (e.g., adding supervisor warning 256 to an action that previously only included re-authentication 252, or the like).

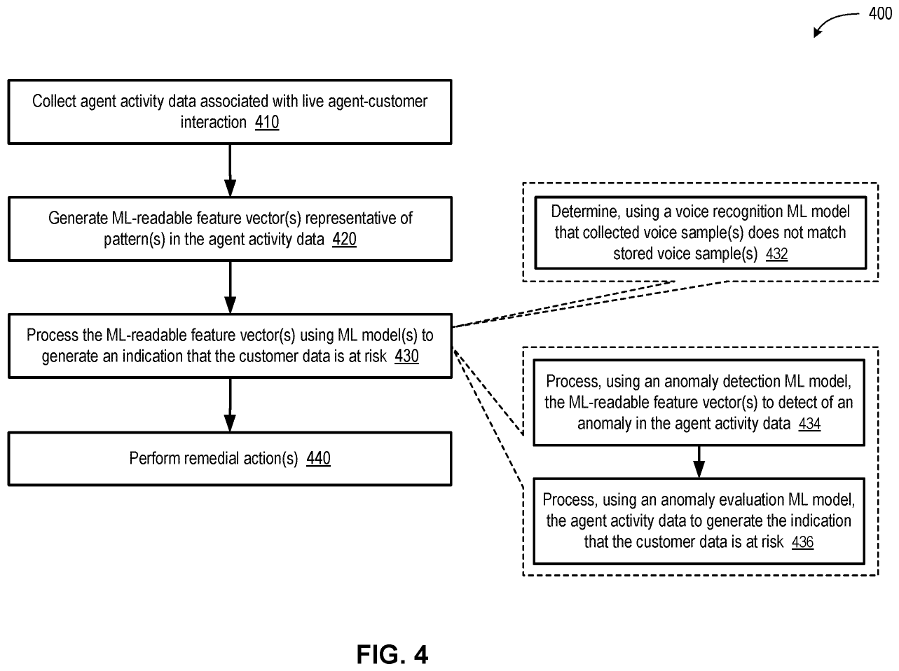

FIG. 4 is a flow diagram of an example method 400 of automated protection of customer data by an interaction center that supports live agent-customer interactivity, in accordance with one or more embodiments of the present disclosure. A processing device, having one or more processing units (CPUs, GPUs, PPUs, DPUs, etc.) and memory devices communicatively coupled to the processing units, may perform method 400 and/or each of its individual functions, routines, subroutines, or operations. The processing device executing method 400 may be a processor 140 of CIC server 120 and/or agent device(s) 110-k of FIG. 1. The processing device performing method 400 may be communicatively coupled to any memory device storing customer data, which may include a permanent data store for such customer data (e.g., data store 160) and/or any memory device that stores such data temporarily (e.g., memory 150). In some embodiments, the processing device executing method 400 may perform instructions issued by ASM 130 that deploys one or more machine learning (ML) models. In certain embodiments, a single processing thread may perform method 400. Alternatively, two or more processing threads may perform method 400, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other. Various operations of method 400 may be performed in a different order compared with the order shown in FIG. 4. Some operations of method 400 may be performed concurrently with other operations. Some operations may be optional. In some embodiments, method 400 may be executed by a cloud-based CIC server with individual operations of the method performed by a single physical computing device or multiple physical computing devices.

At block 410, a processing device performing method 400 may collect agent activity data associated with an instance of a live agent-customer interaction, e.g., a call, chat, video call, email conversation, and/or the like, or some combination thereof. The instance of the live agent-customer interaction may include access by an agent to the customer data. The instance of the live agent-customer interaction should be understood to include a conversation of an agent with a customer, any agent activity leading up to the conversation (e.g., accessing data), and/or any follow-up agent activity after the conversation (e.g., storing and/or recording data). The agent activity data may include (but need not be limited to) voice data 202 and digital activity data 204 (see FIG. 2). In some embodiments, the agent activity data may include a record of the agent accessing the customer data in association with the live agent-customer interaction, a transcript of the live agent-customer interaction, agent activity data associated with one or more previous agent-customer interactions involving the agent, and/or the like.

At block 420, method 400 may include generating one or more ML-readable feature vectors representative of at least one pattern in the agent activity data. An “ML-readable feature vector” refers to a digital (e.g., binary) representation of an information that is capable of being processed by a neural network or some other ML model, including but not limited to a support vector ML model, a decision-tree ML model, a K-Nearest Neighbor Classifier ML model, a gradient boosting ML model, and/or the like. In some embodiments, an “ML-readable feature vector” may include an input into a neural network model, an intermediate product of processing of an input by a neural network model, an intermediate output of a neural network model, and/or a final output of a neural network model. An “ML-readable feature vector” may further include any suitable embedding and/or a similar data object.

At block 430, method 400 may include processing the one or more ML-readable feature vectors using one or more ML models to generate an indication that the customer data is at risk. As illustrated with the top callout portion in FIG. 4, processing the ML-readable feature vectors may include, at block 432, determining that a voice sample of the agent collected during the live agent-customer interaction does not match one or more stored voice samples of the agent. In such embodiments, operations of block 432 may be performed using a voice recognition ML model and the one or more ML-readable feature vectors may include a representation of the voice sample of the agent collected during the live agent-customer interaction and representations of the one or more stored voice samples of the agent.

As further illustrated with the bottom callout portion in FIG. 4, processing the ML-readable feature vectors may be performed, at block 434, to detect an anomaly in the agent activity data. In some embodiments, operations of block 434 may be performed using an anomaly detection ML model (e.g., anomaly detection model 230 in FIG. 2). Method 400 may further include, at block 436, processing, using an anomaly evaluation ML model (e.g., anomaly evaluation model 240 in FIG. 2), a representation of at least a portion of the agent activity data to generate the indication that the customer data is at risk. In some embodiments, operations of block 436 may be performed responsive to the detected (e.g., by the anomaly detection ML model) anomaly in the agent activity data.

In some embodiments, the anomaly evaluation ML model may be trained using a training dataset that includes training input(s) and target output(s). An individual training input may include a representation of a training activity data and the corresponding target output may include a classification output indicative whether the customer data is at risk. In some embodiments, the anomaly evaluation ML model may be pre-trained using one or more initial training datasets prior to deploying the anomaly evaluation ML model. Subsequently, the anomaly evaluation ML model may be re-trained using one more additional training datasets after the deployment of the anomaly evaluation ML model.

At block 440, method 400 may include causing, responsive to the indication that the customer data is at risk, one or more remedial actions to be performed by the interaction center. For example, the remedial action(s) may include sending an authentication request to the agent, sending a warning to the agent, sending a warning to a supervisor of the agent, and/or performing some other similar action and/or a combination thereof.

FIG. 5 depicts an example computer system 500 that can perform any one or more of the methods described herein, in accordance with some embodiments of the present disclosure. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 500 includes a processing device 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)), and a data storage device 518, which communicate with each other via a bus 530.

Processing device 502 (which can include processing logic 503) represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute instructions 522 for implementing method 400 of automated protection of customer data by an interaction center that supports live agent-customer interactivity.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker). In one illustrative example, the video display unit 510, the alphanumeric input device 512, and the cursor control device 514 may be combined into a single component or device (e.g., an LCD touch screen).

The data storage device 518 may include a computer-readable storage medium 524 on which is stored the instructions 522 embodying any one or more of the methodologies or functions described herein. The instructions 522 may also reside, completely or at least partially, within the main memory 504 and/or within the processing device 502 during execution thereof by the computer system 500, the main memory 504 and the processing device 502 also constituting computer-readable media. In some embodiments, the instructions 522 may further be transmitted or received over a network 520 via the network interface device 508.

While the computer-readable storage medium 524 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operations may be performed, at least in part, concurrently with other operations. In certain embodiments, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various embodiments are not intended to limit the scope of the claims, which in themselves recite only those features regarded as the disclosure.

What is claimed is:

1. A computing server of an interaction center that supports live agent-customer interactivity, the server comprising:
a memory device storing customer data, and
one or more processing devices communicatively coupled to the memory device, the processing device to:
collect agent activity data associated with an instance of a live agent-customer interaction, wherein the instance of the live agent-customer interaction comprises access by an agent to the customer data;
generate one or more machine learning (ML)-readable feature vectors representative of at least one pattern in the agent activity data;
process the one or more ML-readable feature vectors using one or more ML models to generate an indication that the customer data is at risk; and
cause, responsive to the indication that the customer data is at risk, one or more remedial actions to be performed by the interaction center.

2. The computing server of claim 1, wherein the one or more ML models comprise a voice recognition ML model, wherein the one or more ML-readable feature vectors comprise a representation of a voice sample of the agent collected during the live agent-customer interaction, and wherein to process the one or more ML-readable feature vectors, the one or more processing devices are to:
determine, using the voice recognition ML model, that the voice sample of the agent collected during the live agent-customer interaction does not match one or more stored voice samples of the agent.

3. The computing server of claim 1, wherein to process the one or more ML-readable feature vectors, the one or more processing devices are to:
process, using an anomaly detection ML model, the one or more ML-readable feature vectors to detect an anomaly in the agent activity data.

4. The computing server of claim 3, wherein to process the one or more ML-readable feature vectors, the one or more processing devices are further to:
process, responsive to the detected anomaly in the agent activity data, using an anomaly evaluation ML model, a representation of at least a portion of the agent activity data to generate the indication that the customer data is at risk.

5. The computing server of claim 3, wherein the anomaly evaluation ML model is trained using a training dataset comprising a training input and a target output, wherein the training input comprises a representation of a training activity data and the target output comprises a classification output indicative of whether the customer data is at risk.

6. The computing server of claim 4, wherein the anomaly evaluation ML model is pre-trained using one or more initial training datasets prior to a deployment of the anomaly evaluation ML model and re-trained using one more additional training datasets after the deployment of the anomaly evaluation ML model.

7. The computing server of claim 1, wherein the agent activity data comprises at least one or more of:
a record of the agent accessing the customer data in association with the live agent-customer interaction,
a transcript of the live agent-customer interaction, or
the agent activity data associated with one or more previous agent-customer interactions involving the agent.

8. The computing server of claim 1, wherein the one or more remedial actions to be performed by the interaction center comprises one or more of:
an authentication request to the agent,
a warning to the agent, or
a warning to a supervisor of the agent.

9. A method of automated protection of customer data by an interaction center that supports live agent-customer interactivity, the method comprising:
collecting, by a processing device, agent activity data associated with an instance of a live agent-customer interaction, wherein the instance of the live agent-customer interaction comprises access by an agent to the customer data;
generating, by the processing device, one or more machine learning (ML)-readable feature vectors representative of at least one pattern in the agent activity data;
processing the one or more ML-readable feature vectors using one or more ML models to generate an indication that the customer data is at risk; and
responsive to the indication that the customer data is at risk, causing, by the processing device, one or more remedial actions to be performed by the interaction center.

10. The method of claim 9, wherein the one or more ML models comprise a voice recognition ML model, wherein the one or more ML-readable feature vectors comprise a representation of a voice sample of the agent collected during the live agent-customer interaction, and wherein processing the one or more ML-readable feature vectors comprises:
determining, using the voice recognition ML model, that the voice sample of the agent collected during the live agent-customer interaction does not match one or more stored voice samples of the agent.

11. The method of claim 9, wherein processing the one or more ML-readable feature vectors comprises:
processing, using an anomaly detection ML model, the one or more ML-readable feature vectors to detect an anomaly in the agent activity data.

12. The method of claim 11, wherein processing the one or more ML-readable feature vectors further comprises:
responsive to the detected anomaly in the agent activity data, processing, using an anomaly evaluation ML model, a representation of at least a portion of the agent activity data to generate the indication that the customer data is at risk.

13. The method of claim 12, wherein the anomaly evaluation ML model is trained using a training dataset comprising a training input and a target output, wherein the training input comprises a representation of a training activity data and the target output comprises a classification output indicative of whether the customer data is at risk.

14. The method of claim 12, wherein the anomaly evaluation ML model is pre-trained using one or more initial training datasets prior to a deployment of the anomaly evaluation ML model and re-trained using one more additional training datasets after the deployment of the anomaly evaluation ML model.

15. The method of claim 9, wherein the agent activity data comprises at least one or more of:
a record of the agent accessing the customer data in association with the live agent-customer interaction,
a transcript of the live agent-customer interaction, or
the agent activity data associated with one or more previous agent-customer interactions involving the agent.

16. The method of claim 9, wherein the one or more remedial actions to be performed by the interaction center comprises one or more of:
an authentication request to the agent,
a warning to the agent, or
a warning to a supervisor of the agent.

17. A non-transitory computer-readable storage medium storing instructions that, when executed by a processing device of an interaction center that supports live agent-customer interactivity, cause the processing device to:
collect agent activity data associated with an instance of a live agent-customer interaction, wherein the instance of the live agent-customer interaction comprises access by an agent to a customer data;
generate one or more machine learning (ML)-readable feature vectors representative of at least one pattern in the agent activity data;
process the one or more ML-readable feature vectors using one or more ML models to generate an indication that the customer data is at risk; and
cause, responsive to the indication that the customer data is at risk, one or more remedial actions to be performed by the interaction center.

18. The non-transitory computer-readable storage medium of claim 17, wherein the one or more ML models comprise a voice recognition ML model, wherein the one or more ML-readable feature vectors comprise a representation of a voice sample of the agent collected during the live agent-customer interaction, and wherein to process the one or more ML-readable feature vectors, the processing device is to:
determine, using the voice recognition ML model, that the voice sample of the agent collected during the live agent-customer interaction does not match one or more stored voice samples of the agent.

19. The non-transitory computer-readable storage medium of claim 18, wherein to process the one or more ML-readable feature vectors, the processing device is further to:
process, responsive to the detected anomaly in the agent activity data, and using an anomaly evaluation ML model, a representation of at least a portion of the agent activity data to generate the indication that the customer data is at risk.

20. The method of claim 12, wherein the anomaly evaluation ML model is trained using a training dataset comprising a training input and a target output, wherein the training input comprises a representation of a training activity data and the target output comprises a classification output indicative of whether the customer data is at risk.
